(19) United States
(12) Patent Application Publication
(10) Pub. No.: US 2021/0205684 A1
(43) Pub. Date: Jul. 8, 2021

(54) Baseball Simulation Game

(71) Applicant: William E. Matory, III, Virginia Beach, VA (US)

(72) Inventor: William E. Matory, III, Virginia Beach, VA (US)

(21) Appl. No.: 17/128,514

(22) Filed: Dec. 21, 2020

Related U.S. Application Data
(60) Provisional application No. 62/957,963, filed on Jan. 7, 2020.

(51) Int. Cl. A63B 69/00; A63B 24/00

(52) U.S. Cl. CPC A63B 69/0002; A63B 24/0021; A63B 2024/0015; A63B 2024/0028; A63B 24/0006

(57) ABSTRACT

This present invention relates to a baseball simulation game. The baseball simulation game comprises one or more bays, a microchipped baseball, and a field into which the baseball is hit by a user positioned in the bay. A plurality of targets and catchers, each comprising a sensor for detecting the baseball, are also positioned in the field in spaced apart fashion. The game assigns points to the player, wherein the amount of points assigned depends on what target or catcher is struck by the baseball. The baseball simulation game is capable of being enjoyed by multiple players simultaneously and can be enjoyed at any time of day and is not dependent on the weather.

### CROSS-REFERENCE TO RELATED APPLICATION

The present application claims priority to, and the benefit of, U.S. Provisional Application No. 62/957,963, which was filed on Jan. 7, 2020 and is incorporated herein by reference in its entirety.

### FIELD OF THE INVENTION

The present invention relates generally to the field of simulation games. More specifically, the present invention relates to a hands-on baseball simulation game, a method of playing the game and a novel scoring mechanism. The baseball simulation game utilizes a field representative of a baseball field, wherein four base zones or areas are indicated on the field. In particular, the first base zone is located nearest to a bay into which baseballs may be hit, and the second base zone has two target zones and is placed behind the first base zone. The third base zone has three target zones and is placed behind the second target zone, and the fourth base zone has four target zones and is located behind the third base zone. The target zones in each of the four base zones have sensors for detecting a microchip in the baseball that is hit by a player from the bay or batting area. The game further comprises a novel scoring mechanism for calculating the score based on the target zone hit by the ball, and a display for displaying the cumulative score as well as information on the distance traveled by the hit ball, its trajectory, and speed. A plurality of metal frame studs acting as catchers are also present in the field of play in different base zones, each having an electric sensor to receive or catch the hit ball. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, baseball has been one of the most popular sports in the United States for a very long time, and is increasing in popularity in other countries, like Japan, Mexico, etc. Given the popularity of the sport, many types of baseball games, including real, electronic and automated, have been developed over the years to provide entertainment to baseball enthusiasts. Because baseball is a game that employs the user of a bat and a ball and is played on a designated field, many individuals that are interested in playing the game may purchase a membership in a sport club or complex to obtain access to the baseball grounds and equipment. Unfortunately, many such memberships are typically expensive, and not everyone can afford the cost of playing the actual game of baseball. Still other ways to enjoy the game of baseball may be offered through schools, intramural organizations, or charitable clubs where fees may not be required, but other restrictions on participation may apply.

For example, such schools, organizations and clubs, regardless of their fee structure or lack thereof, may place limitations on the age of the person playing the game, and typically prohibit children from participating where teenagers or adults are playing out of safety concerns. In such scenarios, the children may become bored while watching others enjoy playing the game of baseball. Additionally, such school, organization or club sponsored baseball games further require a minimal level of participation for the game to be played, typically 9 players per team for a total of 18 players. If enough players are not present, the game may not be played.

Further, while playing the game of baseball, participants and spectators alike need to keep track of the score and statistics and have to always track the baseball manually in order to calculate scores and other statistics for each team or individuals in the game. Manual tracking and score calculation may be frustrating and tiresome, and distracts the score keeper or statistician from enjoying the game. Also, there is a good chance for miscalculation while the baseball game is being played. The miscalculation may have an adverse impact on the teams and/or individuals playing the game.

Therefore, there exists a long felt need in the art for a baseball simulation game which is easily accessible to all users, and that provides entertainment to said users. There is also a long felt need in the art for a baseball simulation game which is easily affordable, and that features automatic scoring without the need to manually track the same. Moreover, there is a long felt need in the art for a baseball simulation game which allows users to actually participate in the game and gives the real feeling of playing baseball. Finally, there is a long felt need in the art for a baseball simulation game that is relatively inexpensive to manufacture and that is safe and easy to use.

The novel baseball simulation game of the present invention, described herein in various embodiments, accomplishes all of the forgoing objectives, and provides an entertaining, accurate, convenient and cost-effective solution for playing the game of baseball. The novel baseball simulation game of the present invention is also user friendly, inasmuch as it is far less expensive than the alternatives, provides a smaller more efficient space for playing the game of baseball, and calculates the score and other game statistics automatically.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a method of playing a baseball game using the baseball simulation game system of the present invention. The game system includes a bay into which the baseballs can be hit, and the method comprises the initial steps of authorizing a player to play the simulation game, and then positioning the player at a position in an allocated bay. Next, the player swings at pitched balls and aims for targets that contains sensors to register the hit of the player. The targets are placed in different base zones in a field, and the game automatically calculates a score when a microchip present in the baseball is read by the sensors imbedded in the targets. The score is then displayed on screens present in the bay and elsewhere, such as the customer or fan section of the baseball simulation game system. The field of the baseball simulation game system is representative of a baseball diamond and outfield, and is divided into four base zones and an “out of the park” zone.

The first base zone is the nearest to the bay or batting area into which baseballs are thrown and swung at, and the second base zone is positioned behind the first base zone and has two targets contained therein. The third base zone is farther from the bay or batting area than both the first base zone and the second base zone, and has three targets contained therein. The fourth base zone is positioned beyond the third base zone (relative to the batter) and is the farthest from the bay of the four base zones. The fourth base zone is comprised of four separate targets, and a section behind the fourth base zone is referred to as the “out of the park” zone. The targets in each of the base zones are comprised of one or more sensors that detect the microchip implanted into the baseballs hit by a player from the bay. Each of the targets is also assigned a point value, wherein the further the target from the batter, the higher the number of points awarded to the batter. Accordingly, a baseball hit by a batter to the “out of the park” zone will received the most points, wherein a baseball hit into a select area in the first base zone will be awarded the lowest number of points.

The subject matter disclosed and claimed herein, in another embodiment thereof, comprises a baseball simulation game for the entertainment of its users. The baseball simulation game and facility comprises laterally placed bay areas in which multiple players can bat to hit baseballs. A baseball pitching machine is provided for each bay to pitch baseballs towards a player, and a field zone representative, such as an umpire or linesman, may be provided for a baseball game field. The baseball stadium (e.g. the diamond, infield and outfield areas) includes a plurality of base zones, with each base zone having targets with sensors and assigned point values. Targets closest to the batter are assigned the lowest point values, and the point values associated with each target increases as the distance from the batter's location increases.

Each of the targets are comprised of a reader or other sensor that reads/detects a microchip installed or imbedded in the baseball to calculate a score of the player that hit the ball when the ball comes into close proximity thereto. A plurality of metal frame studs may also be positioned in the field and act as catchers. The catchers may be in the form of relatively large gloves or receiving mitts to receive or catch the hit baseballs and are also comprised of sensors. When the baseball is caught the player receives a zero score. A scoring mechanism calculates the score and displays the cumulative score information on a display near the bay area where the player is hitting the balls.

In one embodiment of the present invention, the system is comprised of four different base zones. A first base zone is nearest to a bay into which the baseballs are hit. The first zone comprises a plurality of targets that generate a score in the range of 5-10 points for the player when hit. The second base zone is positioned immediately behind the first base zone and has two targets, wherein each of the two targets are comprised of a plurality of sub-targets that, when hit by the baseball, yield a score in the range of 15-30 points for a player. The third base zone is positioned immediately behind the second base zone and has three targets, wherein each of the three targets are comprised of a plurality of sub-targets that, when hit by the baseball, yield a score in the range of 40-60 points for a player. The fourth base zone is positioned immediately behind the third base zone and has four targets, wherein each of the four targets are comprised of a plurality of sub-targets that, when hit by the baseball, yield a score in the range of 70-80 points for a player and further wherein at least one of the four targets is larger in size than at least one of the other three targets in the fourth base zone. The section positioned immediately behind the fourth base zone is the “out of the park” zone, which gives 100 points to a player if struck by the micro-chipped baseball. Further, the above referenced gloves/mitts may be present in any one or more of the four base zones, and result in zero points being awarded if struck by the baseball.

In a further preferred embodiment, the baseball simulation game is programmed to associate particular baseballs with particular players in a multiplayer competition game. That is, the microchip is programmed to correspond to a particular player at the start of a game. Then, when the microchip is detected by the sensor in one of the targets, the score attributable to that target is assigned to the batter associated with the particular baseball and may then be displayed for that player. The microchip can be programmed with a unique identifier of the player for unique association of the player and the baseball. The identifier may be provided in alpha numeric symbols (ABC123) or binary representation (a series of “0's” and “1's”, such as 000111000101001). To score, a player aims his or her shot of the baseball for targets which contain sensors to register hits, and, in appropriate sections, balls may be registered as outs such as when caught by the gloves or mitts, or runs when the ball lands in zones not occupied by gloves or mitts.

The subject matter disclosed and claimed herein, in a further embodiment thereof, comprises a baseball simulation game for the entertainment of users. The baseball simulation game has a bay area for batting or hitting baseballs, wherein a plurality of targets are located in the bay area and include a number of sensors for registering hits. A fence at the end of the bay area is also provided for registering a home run. Baseballs containing microchips for identifying the balls are associated with or attributed to the players, and are hit into the bay area at the various targets, wherein points are assigned to a player for hitting a desirable target and zero points are assigned for hitting an undesirable target. A server is also provided for storing information regarding the game, and a processor is used for processing the data collected by the various sensors, microchips and other components of the game.

The subject matter disclosed and claimed herein, in yet another embodiment thereof, comprises a baseball recreational system having a field representative of a baseball field. The field may be comprised of natural or artificial turf, and includes a plurality of non-overlapping symmetric base zones demarcated (one behind the other) across the field. Each base zone comprises one or more targets having a sensor to register hits and provide scores when the baseball hits the targets. Metal frame studs act as catchers or outfielders, and also have electric sensors for registering “outs” if hit. More specifically, when a ball is caught by the mitt or glove, a zero score is given to a player which is indicative of an “out” in baseball. Similarly, players are awarded points for hitting desirable targets, wherein the further away the target from the batter, the more points that are awarded for striking the same. The present invention automatically associates or attributes particular balls with specific players to allow for multiplayer competitions, and features a child mode that always awards points to a child playing the game, regardless of what target is hit.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a diagrammatic representation of one possible embodiment of the baseball simulation game of the present invention and its various components in accordance with the disclosed architecture;

FIG. 2 illustrates a graphical representation of one potential embodiment of the field and various bays of the baseball simulation game of the present invention in accordance with the disclosed architecture; and

FIG. 3 illustrates a flow diagram of one potential embodiment of the method of playing the baseball simulation game of the present invention in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a baseball simulation game that is easily accessible to users or all ages and background, and that provides entertainment to said users. There is also a long felt need in the art for an affordable baseball simulation game that features automatic scoring, and a unique scoring system. Moreover, there is a long felt need in the art for a baseball simulation game which allows users to actually participate in the game, and gives the user the experience of playing real baseball. Finally, there is a long felt need in the art for a baseball simulation game that is relatively inexpensive to manufacture and that is safe and easy to use.

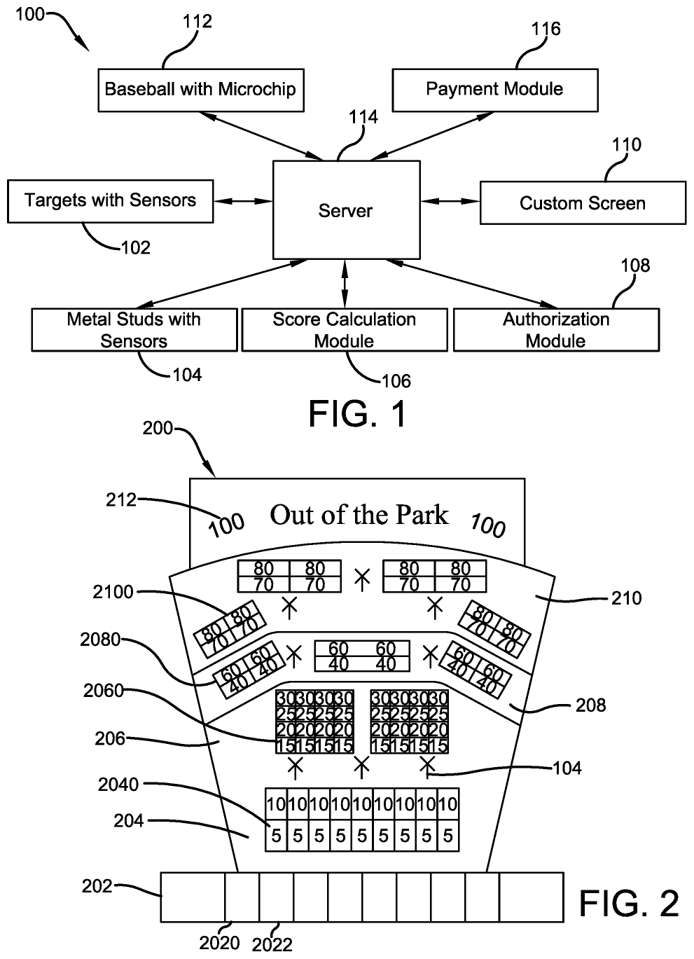

Referring initially to the drawings, FIG. 1 illustrates a diagrammatic representation of one possible embodiment of the baseball simulation game 100 of the present invention and its various components in accordance with the disclosed architecture. More specifically, the baseball simulation game 100 is a computer implemented or supported system, wherein a central server 114 is in contact with various modules used in the baseball simulation game 100. The central server gathers, processes and stores the various data and other information received from the modules, and provides instructions thereto to efficiently run the baseball simulation gaming system 100. For information, the data collected by the central server 114 may include, but is not limited to, information relating to the individual players, subscription information, skill sets, prior scores, and any other details that may enhance the play of the individual of the system 100.

The server 114 coordinates with an authorization module 108, which authorizes a player to enter a bay area for hitting the baseballs 112. More specifically, a payment module 116 receives the payment details of the player and sends the information to the server 114. The payment module 116 may receive the player's payment in both online and offline modes, and may process credit card information or take cash or coins as payment for the session. Prior to authorizing the player to participate in the game, the authorization module 108 verifies the membership and payment details of the player and, if appropriate, transmits the authorization code to the authorization module 108 to allow the player to partake in the simulation game.

A score calculation module 106 is also included, and is programmed to score the game based on the target 102 which has registered a hit from an authorized player. More specifically, the target 102 has sensors that read the microchip present in the baseball 112 to transmit the hit information to the score calculation module 106 through the server 114. The server 114 also associates particular baseballs 112 with particular players if multiple players are competing at the same time, and contacting targets simultaneously from the different bays. Catching stands or receiving mitts 104 that may be supported by posts or studs and act as outfielders may also transmit scoring information to the score calculation module 106 through the server 114 when the baseball 112 is received/detected by the catching stands or receiving mitts 104.

A customer screen 110 may also be present in the bay area or in a customer viewing area. The customer screen 110 may display the details of the game including, without limitation, live scores, winning status, player name, player statistics, etc. In a further embodiment, a voice signal generator (not shown) may also be present to emit audio and/or spoken words such as, but not limited to, “Out”, “Foul Ball”, “Hit”, “Two-base hit”, “Three-base hit”, “Home run”, or any other user specified sounds or words. The voice signals may be emitted from a loud speaker connected to the voice signal generator to inform the players and spectators about the various results.

In the field, the sensors on the targets 102 read the microchip(s) in the baseball 112 and, together with the score calculation module 106, calculate the score of each player (even if multiple players are participating at the same time from different bays) and display the score on the customer screen 110. The targets 102 may further comprise digital signage and/or different color LED lights that are turned on automatically at night, or manually at any time that a game is being played. The targets 102 and catchers 104 are pre-programmed for a specific scoring style, but may be re-programmed using the server 114, for example, to modify the game to suit user need and/or preference (e.g., different modes of play).

As explained more fully below, the field representative of the baseball simulation game 100 has targets 102 and gloves or mitts supported by metal supports 104 at a plurality of different spaced apart locations on the field, which is comprised of a plurality of different base zones. The plurality of different base zones enable different scores to be achieved depending on what target in what base zone the player hits with the chip embedded baseball 112. Notwithstanding, it should be appreciated that any other additional component, whether it be hardware and/or software, can also be utilized to increase the functionality, security and efficiency of the baseball simulation gaming system 100 of the present invention.

FIG. 2 illustrates a graphical representation of one potential embodiment of the field 200 and various bays 2020, 2022, etc. of the baseball simulation game 100 of the present invention in accordance with the disclosed architecture. More specifically, the field 200 is preferably housed within a building 202 so that the baseball simulation game 100 can be enjoyed year round, day or night, and in all weather conditions. The field 200 is preferably comprised of four separate base zones or areas, namely a first base zone 204, a second base zone 206, a third base zone 208, and a fourth base zone 210, and an “out of the park” area 212. During the baseball simulation game, one or more players hit the microchipped baseballs 112 into the various base zones 204, 206, 208, 210, or the “out of the park” area 212 to achieve a score.

The first base zone 204 is positioned nearest and adjacent to the plurality of bays 2020, 2022, etc., and is further comprised of a plurality of different first base zone targets 2040 that are part of a larger target, as best shown in FIG. 2, and a plurality of spaced apart catchers 104. When hit with the baseball 112, the first base zone targets 2040 award a player with a point value of between 5 and 10 points. Conversely, when a player hits one of the catchers 104 positioned in the first base zone 204 with the baseball 112, it is considered an “out”, and no points are awarded. Essentially, the plurality of catcher stands 104 act as outfielders and are comprised of electric sensors in relatively large gloves or mitts to receive the struck baseball 212.

The second base zone 206 is positioned immediately beyond and adjacent to the first base zone 204, and is further comprised of a plurality of different second base zone targets 2060 that are part of a pair of larger targets, as best shown in FIG. 2, and a plurality of spaced apart catchers 104. When hit with the baseball 112, the second base zone targets 2060 award a player with a point value of between 15 and 30 points, wherein the points awarded increase the further into the second base zone 206 that the hit baseball 112 travels from the bays 2020, 2022, etc.. Conversely, when a player hits one of the catchers 104 positioned in the second base zone 206 with the baseball 112, it is considered an “out”, and no points are awarded.

The third base zone 208 is positioned immediately beyond and adjacent to the second base zone 206, and is further comprised of a plurality of different third base zone targets 2080 that are part of a set of larger targets, preferably three targets as best shown in FIG. 2, and a plurality of spaced apart catchers 104. When hit with the baseball 112, the third base zone targets 2080 award a player with a point value of between 40 and 60 points, wherein the points awarded increase the further into the third base zone 208 that the hit baseball 112 travels from the bays 2020, 2022, etc.. Conversely, when a player hits one of the catchers 104 positioned in the third base zone 208 with the baseball 112, it is considered an “out”, and no points are awarded.

The fourth base zone 210 is positioned immediately beyond and adjacent to the third base zone 208, and is further comprised of a plurality of different fourth base zone targets 2100 that are part of a set of larger targets, preferably four targets as best shown in FIG. 2, and a plurality of spaced apart catchers 104. When hit with the baseball 112, the fourth base zone targets 2100 award a player with a point value of between 70 and 80 points, wherein the points awarded increase the further into the fourth base zone 208 that the hit baseball 112 travels from the bays 2020, 2022, etc.. Conversely, when a player hits one of the catchers 104 positioned in the fourth base zone 210 with the baseball 112, it is considered an “out”, and no points are awarded. The section of the field immediately behind the fourth base zone 210 is the “out of the park” zone 212 which, if hit by the baseball 112 awards the player the maximum of 100 points.

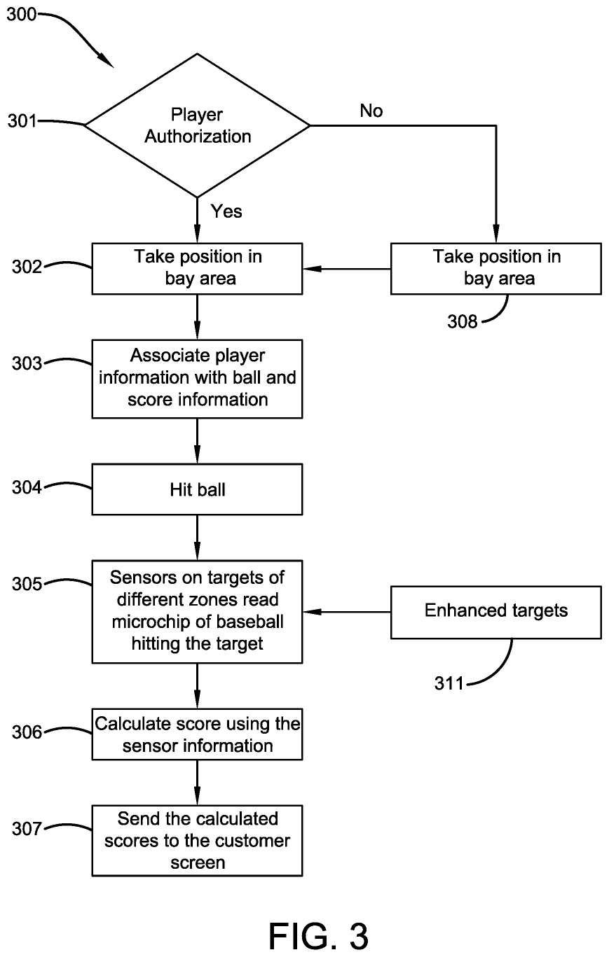

In an alternative embodiment of the baseball simulation game 100, when hit by the baseball 112: (a) the first base zone targets 2040 may award the player with a score in the range of 2-15 points; (b) the second base zone targets 2060 may award the player with a score in the range of 15-25 points; (c) the third base zone targets 2080 may award the player with a score in the range of 25-50 points; and (d) the fourth base zone targets 2100 may award the player with a score in the range of 50-80 points. Further, the number of targets may be proportional to the zone into which the baseballs 112 are hit. That is, the closer the zone, the fewer the number of targets, and the further away the zone, the higher number of targets. Notwithstanding, it should be appreciated that any other combination of scores and the number of base zones are possible under the scope of the invention. Further, the scores can be programmed using the server 114, wherein the score calculation can be different for striking different targets. In addition, the point totals of various targets may also be enhanced on a random basis to increase the excitement of the game, and give the players the opportunity to be rewarded for hitting a particular target that has been optimized, such as is shown in FIG. 3.

All the targets and catchers or outfielders 104 present in the field 200 have sensors to read the microchip of the baseball 112 hit by the player. The sensors can also detect the speed, spin rate and distance of the hit made by the player. The sensors transmit the information from the baseball 112 back to the server 114 and score calculation module 106. The microchip can store data or other information pertaining to the game of the player with which the baseball 112 is associated. In one embodiment, a child mode of the baseball simulation game 100 is also available that will always award a child participant with points regardless of where the baseball 112 lands and/or what target it strikes.

As best shown in FIG. 2, the various bays 2020, 2022, etc. for the players are laterally spaced and immediately adjacent to the first base zone 204. In this manner, multiple players can simultaneously play the baseball simulation game 100 of the present invention from the different bays 2020, 2022 and using the same field 200. Alternatively, multiple players (e.g., a family or a group of friends) can play the baseball simulation game 100 from the same bay 2020 using the same field zone 200.

FIG. 3 illustrates a flow diagram of one potential embodiment of the method 300 of playing the baseball simulation game 100 of the present invention in accordance with the disclosed architecture. More specifically, the method begins at step 301 wherein the player authorization is performed by the server 114 in coordination with the authorization module 108. If authorization is denied, the player is not provided with access to the bay area 2020, 2022, and the method terminates at step 308. If on the other hand authorization is granted, the player will be provided with access to a select bay area 2020, 2022 to participate in the simulation game 100.

At step 302, the authorized player takes his or her position in the bay area 2020, 2022 and a baseball 112 having a microchip therein is programmed to be associated with that particular player at step 303. In this manner, multiple players can hit their associated baseball 112 into the field 200 at the same time, and each player's score and other related statistics will be tracked by the baseball simulation system 100 of the present invention. More specifically, the associated baseball 112 is thrown in the direction of the player by a pitching machine and may be hit by the player at step 304. Then, once the baseball 112 enters the field, it is registered by the sensor(s) embedded in the target struck by the baseball 112, and an appropriate score is assigned to the player that struck the ball at step 305.

More specifically, the sensor or reader in the target 102 may have a read range of between 1 and 10 meters depending on the points to be awarded by the target. For example, a target that awards fewer points would preferably have a larger read range versus a target with a greater point allocation which would have a shorter read range. In this manner, the player is challenged to hit the baseball 112 closer to those targets with a higher point total than those of a smaller point total. Additionally, microchip embedded in the baseball 112 can be either active or passive. In an active system, the baseball 112 would include a power supply, such as a battery, so that the chip could regularly emit a signal to be picked up by the target. In a passive system, the chip is energized by the energy from the target itself, and then transmits a signal back to the target that the baseball/chip 112 is close to the target to score the points. In one embodiment of the present invention, anti-collision RFID technology may be used to identify baseballs 112. Under this arrangement, multiple baseballs 112 can be read simultaneously.

At step 306, the player's score is calculated by the score calculation module 106, and may be displayed on the player's screen 110 at step 307. The score calculations may also be stored with a player ID for the player's future reference and/or transmitted and displayed in the player's smartphone or other device. Enhanced point targets can also be provided at step 311, wherein the target point totals may be randomized to increase the excitement of the game and award the player for hitting different targets during a game session.

In one embodiment of the present invention, the field 200 may be roughly the same dimensions of an actual baseball field. Alternatively, the field 200 may be approximately 80% of the size of an actual baseball field, or any other acceptable percentage. Further, the targets 102 and catchers 104 may be removably installed on the field 200 so that they can be repositioned to make the simulated game more challenging when repeat customers return to the facility 202. The various base zones, 204, 206, 208, 210 may also be color coded or of different colors for differentiation purposes. For example, in one embodiment, the first base zone 204 and the targets 2040 and catchers 104 positioned therein may be painted or illuminated with the color red (or any other suitable color), wherein the second base zone 206 and the targets 2060 and catchers 104 positioned therein may be painted or illuminated with a second color and so on and so forth. Any other combination of colors falls within the scope of the invention.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “baseball simulation game system”, “baseball game”, and “recreational baseball game”, are interchangeable and refer to the baseball simulation game system 100 of the present invention.

Notwithstanding the forgoing, the baseball simulation game system 100 of the present invention and its various components can be of any suitable configuration as is known in the art without affecting the overall concept of the invention, provided that they accomplish the above stated objectives. One of ordinary skill in the art will appreciate that the size, and configuration of any of the components, field zone 200, targets 102, catchers 104, etc., as shown in the FIGS. are for illustrative purposes only, and that many other sizes and configurations of the baseball simulation game system 100 and its various components are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A simulation game comprising:
a field comprised of a first zone, a second zone, a third zone, and a fourth zone;
at least one target positioned in each of the first, second, third and fourth zones, wherein each of the at least one targets is comprised of a sensor;
at least one outfielder positioned in each of the first, second, third and fourth zones, wherein each of the at least one outfielders is comprised of a reader;
a ball having an integrated microchip that is capable of being detected by both the sensor and the reader; and
a display.

2. The simulation game as recited in claim 1, wherein the number of at least one fielders is proportional to the zone in which the at least one outfielder is positioned in.

3. The simulation game as recited in claim 1, wherein the integrated microchip is one of a passive microchip or an active microchip.

4. The simulation game as recited in claim 1, wherein a number of points are assigned when the ball strikes the at least one target, and the number of points assigned varies across the first, second, third and fourth zones.

5. The simulation game as recited in claim 1, wherein each of the at least one target has a read range and the read range corresponds to a point range.

6. The simulation game as recited in claim 1, wherein the simulation game awards a fewer number of points if the ball lands in the first zone than in each of the second, third and fourth zones.

7. The simulation game as recited in claim 1 further comprising an additional zone having a maximum point award.

8. The simulation game as recited in claim 1, an out is recorded is the ball strikes any of the at least one outfielders.

9. The simulation game as recited in claim 1, wherein each of the first zone, the second zone, the third zone, and the fourth zone have a different point value assigned to them.

10. The simulation game as recited in claim 5, wherein the read range is from about 1 to about 10 meters from the at least one target.

11. The simulation game as recited in claim 3, wherein the active microchip comprises an internal power source.

12. The simulation game as recited in claim 3, wherein the passive microchip is powered by the sensor in the at least one target.

13. A baseball simulation game comprising:
a hitting area;
a plurality of base zones;
a baseball comprised of a microchip;
at least one target positioned in each of the plurality of base zones; and
at least one catcher positioned in each of the plurality of base zones.

14. The baseball simulation game of claim 13, wherein each of the at least one targets is comprised of a reader for reading the microchip.

15. The baseball simulation game of claim 13, wherein each of the at least one catchers is comprised of a sensor for sensing the microchip.

16. The baseball simulation game of claim 13, wherein a number of points are assigned to a player if the at least one target is struck by the baseball.

17. The baseball simulation game of claim 13, wherein no points are assigned to a player if the at least one catcher is struck by the baseball.

18. A baseball simulation game comprising;
a first zone having a first point range, a second zone having a second point range, a third zone having a third point range, a fourth zone having a fourth point range, and an additional zone having a bonus point value, wherein the bonus point value is larger than each of the first, second, third and fourth point ranges;
at least one catcher positioned in each of the first, second, third and fourth zones;
at least one target positioned in each of the first, second, third and fourth zones;
a baseball comprising a microchip;
a server in communication with each of the at least targets and at least one catchers; and
a display in communication with the server.

19. The baseball simulation game as recited in claim 18, wherein the microchip is capable of being detected by each of the at least one target and the at least one catcher.

20. The baseball simulation game as recited in claim 18, wherein a point value is associated with each of the at least one targets.
